(19) United States
(12) Patent Application Publication
(10) Pub. No.: US 2018/0126535 A1
(43) Pub. Date: May 10, 2018

(54) MAGNETIC RETENTION DEVICE FOR A HYDRAULIC HAMMER BUSHING

(71) Applicant: Caterpillar Inc., Peoria, IL (US)

(72) Inventor: Austin William Neathery, Waco, TX (US)

(73) Assignee: Caterpillar Inc., Peoria, IL (US)

(21) Appl. No.: 15/344,307

(22) Filed: Nov. 4, 2016

(51) Int. Cl. B25D 17/00; F16J 15/34; B25D 17/08

(52) U.S. Cl. CPC B25D 17/005; B25D 2250/141; B25D 17/08; F16J 15/3444

(57) ABSTRACT

A method for attaching a bushing to a hammer assembly using a magnetic retention device comprises inserting a bushing into an aperture of the hammer assembly along a longitudinal axis of the aperture until the bushing reaches a holding zone of the magnetic retention device disposed along the longitudinal axis, and rotating the bushing until the bushing reaches the locking zone of the magnetic retention device disposed along the longitudinal axis.

### TECHNICAL FIELD

The present disclosure relates to bushings that allow work tools such as hammer bits and the like to be attached to a machine. Specifically, the present disclosure relates to a bushing that eliminates the need to use a cross-pin to hold such a bushing in place in the front head of such a machine.

### BACKGROUND

FIG. 1 illustrates an exemplary disclosed machine 10 having a hydraulic hammer assembly 12. Machine 10 may be configured to perform work associated with a particular industry such as, for example, mining or construction. Machine 10 may be a backhoe loader (shown in FIG. 1), an excavator, tool carrier, a skid steer loader, or any other type of machine. Hammer assembly 12 may be pivotally connected to machine 10 through a boom 14 and a stick 16. Alternatively, hammer assembly 12 may be connected to machine 10 in another way.

Machine 10 may include a hydraulic supply system (not shown in FIG. 1) for moving and powering hammer assembly 12. For example, machine 10 may include a pump (not shown) connected through one or more hydraulic supply lines (not shown) to hydraulic cylinders 18 associated with boom 14 and stick 16, and to hammer assembly 12. The hydraulic supply system may supply pressurized fluid, for example oil, from the pump to the hydraulic cylinders 18 and hammer assembly 12. Hydraulic cylinders 18 may raise, lower, and/or swing boom 14 and stick 16 to correspondingly raise, lower, and/or swing hammer assembly 12. Operator controls for movement of hydraulic cylinders 18 and/or hammer assembly 12 may be located within a cab 20 of machine 10.

As shown in FIG. 1, hammer assembly 12 may include a housing 22, which may be connected to stick 16. A work tool 24 may be operatively connected to an end of housing 22 opposite stick 16. It is contemplated that work tool 24 may include any tool capable of interacting with hammer assembly 12. For example, work tool 24 may include a chisel bit, moil point, percussion buster, blunt tool, ramming tool, tamping plate, cutter, or other hammer bit. Although not shown, a reciprocating piston may be powered hydraulically to move the hammer bit up and down.

As best seen with reference to FIGS. 2 and 3, the housing 22 contains the front head 26, holding a bushing 28, which provides a sliding interface for the hammer bit as the hammer bit moves up and down. Currently hammer bushings 28 have to be held in the front head 26 of the hammer with a cross pin 30 that is inserted into the bore 32 of the front head 26 and mates with a groove 34 disposed on the circumference 36 proximate the upper end 38 of the bushing 28. This requires special geometry in the front head 26 and bushing 28 itself. The pins 30 often wear out or break due to vibration. The bore 32 that houses the pin 30 has clearance where grease can sometimes leak to the outside of the front head 26. This may be undesirable.

Accordingly, it is desirable to provide a device that can effectively hold the bushing in the front head without the need of using a pin, bores or grooves.

### SUMMARY

A bushing is provided comprising a generally annular cylindrical body defining a longitudinal axis, a radial direction and a circumferential direction. The bushing also includes a first end and a second end disposed along the axis and defines a thru-hole extending from the first end to the second end, wherein the first end includes magnetic properties varying along the circumferential direction of the bushing.

A hammer assembly configured to receive a bushing and hold the bushing using a magnetic retention device is provided. The hammer assembly comprises a front head defining a bushing receiving aperture including a free end defining the bushing receiving aperture and a shoulder disposed in the aperture configured to abut the bushing, wherein the aperture defines a longitudinal axis, a radial direction and a circumferential direction, and wherein the shoulder includes magnetic properties varying along the circumferential direction of the aperture.

A method for attaching a bushing to a hammer assembly using a magnetic retention device is provided. The method comprises inserting a bushing into an aperture of the hammer assembly along a longitudinal axis of the aperture until the bushing reaches a holding zone of the magnetic retention device disposed along the longitudinal axis, and rotating the bushing until the bushing reaches the locking zone of the magnetic retention device disposed along the longitudinal axis.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a perspective view of a machine using a hammer bit in a manner known in the art.

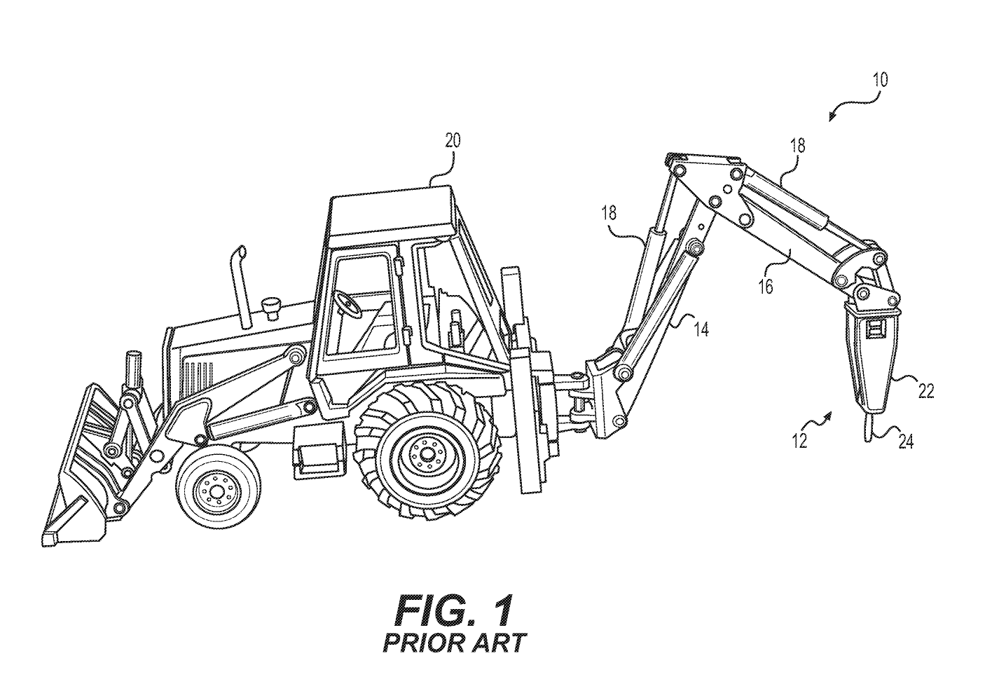

FIG. 2 is a perspective view of a bushing held in the front head of machine of FIG. 1 using a pin.

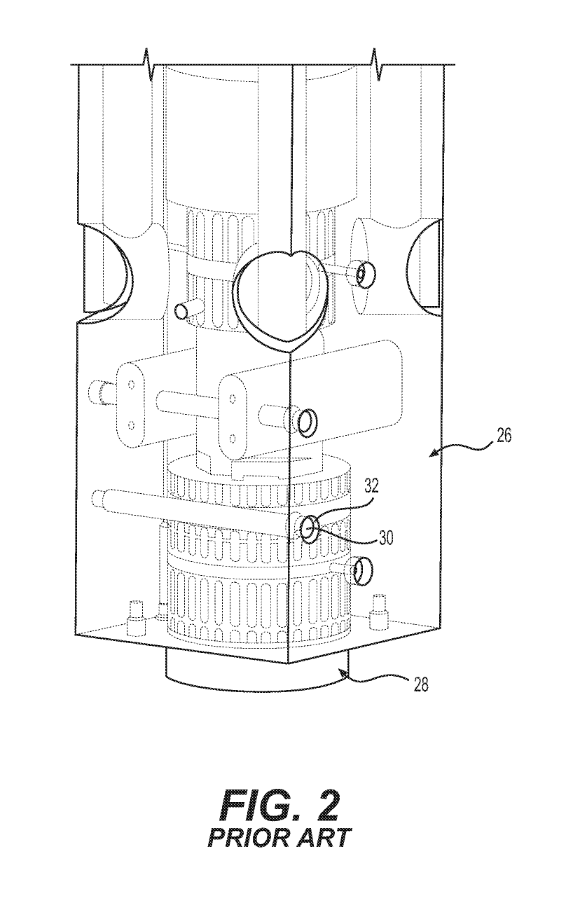

FIG. 3 is an exploded assembly view of FIG. 2, illustrating how a pin mates with a bore of the front head and the groove of the bushing, holding the bushing into place.

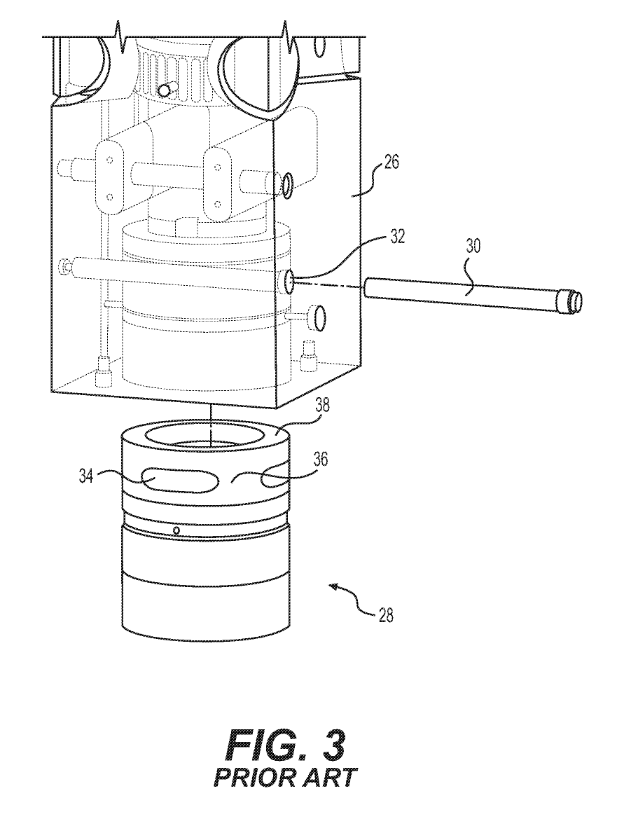

FIG. 4 is front cross-sectional view of a bushing, the front head and a magnetic retention device according to an embodiment of the present disclosure.

FIG. 5 illustrates the bushing having been placed in the pull or hold zone of the magnetic retention device of FIG. 4.

FIG. 6 depicts the bushing having been rotated, causing the bushing enter the lock zone of the retention device of FIG. 4.

FIGS. 7 and 8 explain the magnetic principle that allows the magnetic retention device to hold and then lock the bushing into place by inserting the bushing into the front head and then rotating the bushing.

FIG. 9 is a flowchart of a method for assembling a bushing into a front head of a machine using a magnetic retention device according to an embodiment of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b etc. It is to be understood that the use of letters immediately after a reference number indicates that these features are similarly shaped and have similar function as is often the case when geometry is mirrored about a plane of symmetry. For ease of explanation in this specification, letters will often not be included herein but may be shown in the drawings to indicate duplications of features discussed within this written specification.

The inventor of the present disclosure proposes a magnetic retention device for holding a bushing into the front head of a hammer assembly. Using programmable magnets made using 3D magnet printing technology, the magnetic retention device would provide a magnetic attraction that is alignment dependent between the bushing and the front head of the hammer assembly so that in a first position, the bushing would be inserted into the aperture of the front head in a first alignment and held in place but not locked into place. Then, the bushing would be rotated until a second alignment is reached, increasing the magnetic force and locking the bushing into place.

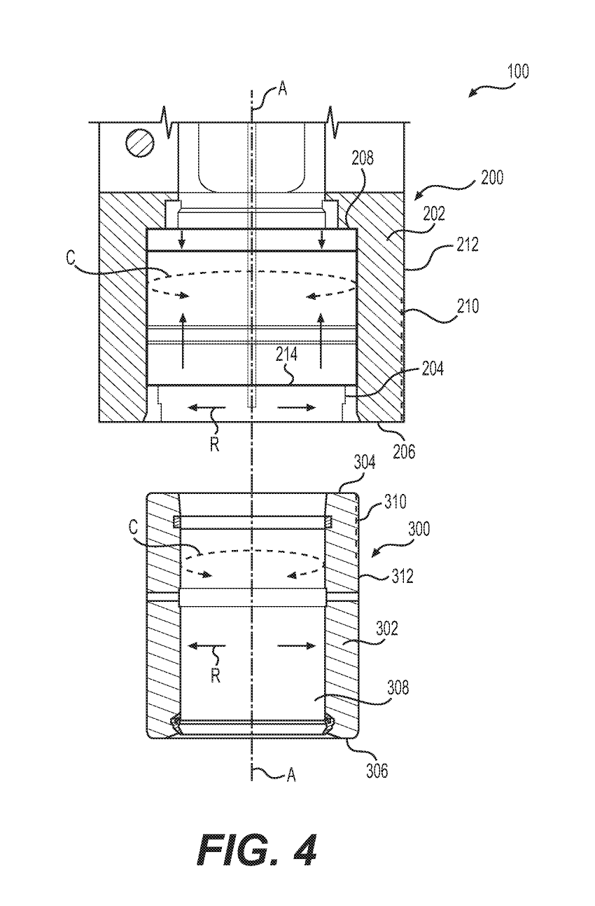

FIGS. 4-6 illustrate an embodiment of a magnetic retention device 100 comprising a hammer assembly 200 and a bushing 300 that will now be described. Starting with FIG. 4, a hammer assembly 200 is shown that is configured to receive a bushing 300. The hammer assembly 200 comprises a front head 202 defining a bushing receiving aperture 204. The free end 206 of the front head 202 defines the bushing receiving aperture 204 and a shoulder 208 disposed in the aperture 204 that is configured to abut the bushing 300. The aperture 204 defines a longitudinal axis A, a radial direction R and a circumferential direction C, and the shoulder 208 includes magnetic properties varying along the circumferential direction C of the aperture 204.

Similarly, FIG. 4 also depicts a bushing that is configured to be inserted into the aperture of the front head. The bushing 300 comprises a generally annular cylindrical body 302 defining a longitudinal axis A, a radial direction R and a circumferential direction C. A first end 304 and a second end 306 are disposed along the axis A and the bushing defines a thru-hole 308 extending from the first end 304 to the second end 306, wherein the first end 304 also includes magnetic properties varying along the circumferential direction C of the bushing 300. The thru-hole 308 is configured to receive a hammer bit or the like, providing a way to reduce friction as the hammer bit slides up and down.

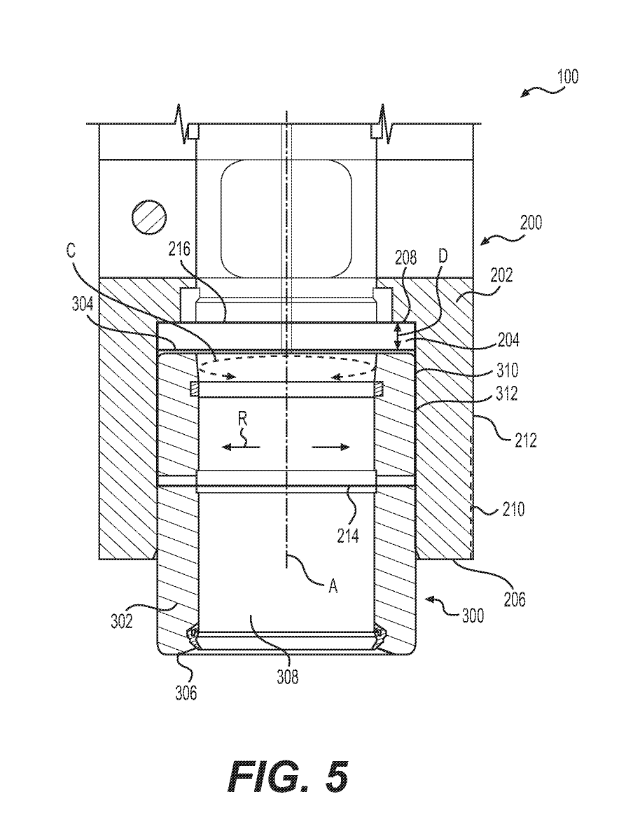

As shown in FIG. 4, indicia 210 may be placed on the side first side 212 of the front head 202 and indicia 310 may be placed on the circumference 312 of the bushing 300, providing a visual cue to the installer on the proper initial alignment between the bushing 300 and the front head 202. That is to say, the installer would be instructed to align these indicia 210, 310 up circumferentially as the bushing 300 is installed into the aperture 204 axially. Provided that this alignment step is achieved before the bushing reaches the “pull zone” 214, the two phase installment process will work as intended. The “pull zone” 214 is so called as once the first end 304 of the bushing 300 reaches the pull zone 214, the magnetic force between the first end 304 of the bushing 300 and the shoulder 208 of the aperture 204 of the front head 202 would be sufficient to hold the bushing 300 in the aperture but not lock it into place. In fact, in many embodiments the first end 304 would hover a predetermined distance D away from the shoulder 208 as illustrated in FIG. 5.

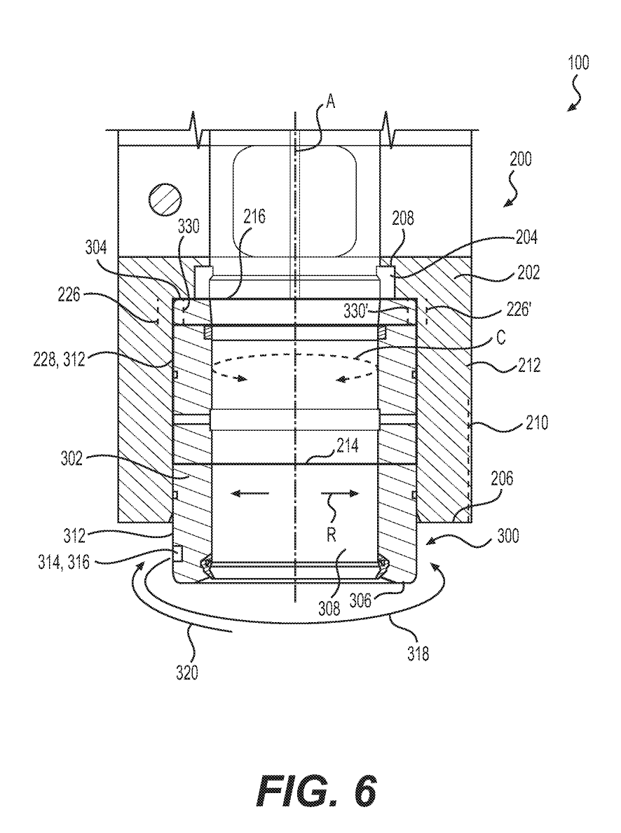

Next, as illustrated in FIG. 6, the installer would rotate the bushing 300 a suitable amount in a first circumferential direction 318, which would increase the magnetic attraction between the bushing 300 and the front head 202 to a point where the bushing would reach the “lock zone” 216, so called, as the bushing 300 would be fully seated into the aperture 204 of the front head 202 of the hammer assembly 200, and could not be pulled out of the aperture 204 along the axial direction with a force usually encountered during operation of a hammer bit or the like. A second set of indicia may be provided on the front head 202 on a second side (not shown but to be understood to be present on the blind side of the front head in FIG. 6), to provide a visual cue to the installer or operator that the bushing 300 is locked into place. For example, the indicia 310 on the circumference 312 of the bushing 300 (shown in FIGS. 4 and 5) may line up with another line or the like on the far face of the front head, indicating that the bushing is locked.

Once locked into place, it may be necessary to use a tool to remove the bushing 300. To that end, a tool interface 314 such as a cavity 316 may be placed on the circumference 312 of the bushing 300 proximate the second end 306 such as shown in FIG. 6. A spanner wrench or the like may be provided that is inserted into the cavity, allowing enough torque to be applied to the bushing to unlock the bushing by rotating the bushing in the opposite circumferential direction 320. Then, pulling down axially on the bushing 300 may remove it from the aperture 204 of the front head 202. It should be noted that the magnetic forces may be of sufficient force to counteract the force of gravity as the front head will often be vertical during installation and removal of the bushing from the front head.

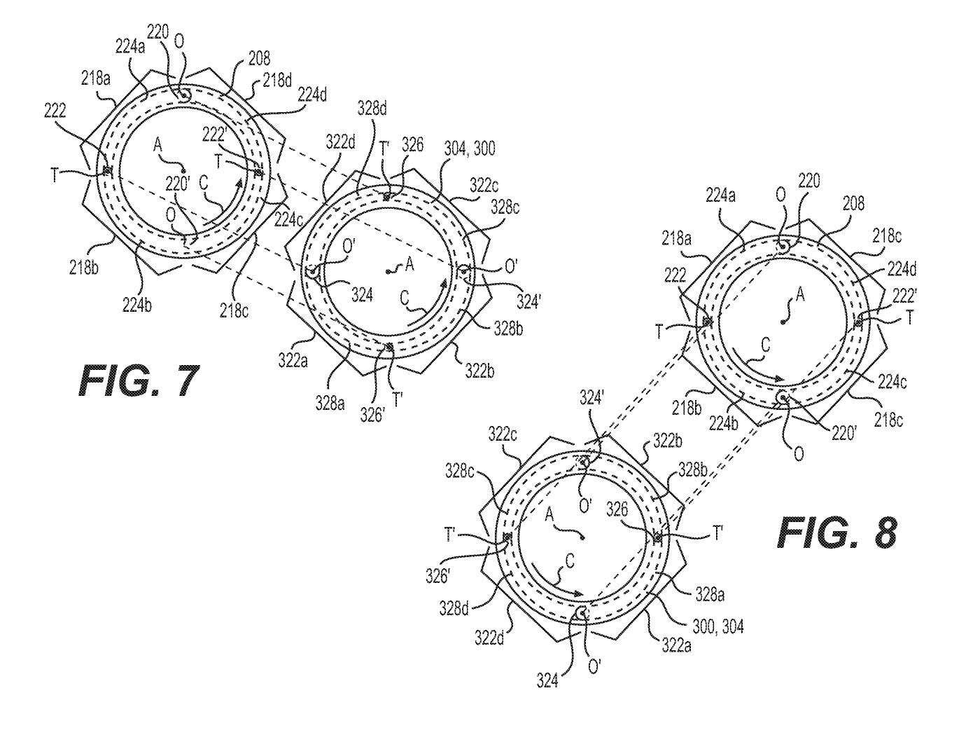

Referring now to FIGS. 7 and 8, an example of how the magnetic properties of the first end 304 of the bushing 300 and the shoulder 208 of the aperture 204 of the front end 202 of the hammer assembly 200 may vary to create the pulling and locking effects will be explained. The shoulder 208 may define four ninety-degree quadrants 218 and the magnetic properties may vary in each of the four quadrants. The shoulder may define a surface normal, parallel with the axial direction A of the aperture 204, and two quadrants 218a, and 218c may include an origin O and a terminus T when viewed along the surface normal, wherein the origin defines a region 220 of a first magnetic intensity and the terminus T defines a region 222 of a second magnetic intensity that is different than the first magnetic intensity. In these two quadrants, the origin O may precede the terminus T along the counterclockwise circumferential direction, and the first magnetic intensity of the region 220 about the origin may exceed the second magnetic intensity of the region 222 about the terminus T.

As shown in FIGS. 7 and 8, in each quadrant 218 there may be a steady gradient 224 of magnetic intensity along the circumferential direction C from the origin O to the terminus T. This variance in magnetic properties may be achieved in a number of ways. For example, each quadrant may include different materials having different magnetic properties along the circumferential direction and/or each quadrant may include magnetic regions having a different surface area. The surface area of the magnetic regions may be continuous or discretized into many small regions, etc.

Likewise, FIGS. 7 and 8 illustrate that the first end 304 of the bushing 300 may also define four ninety-degree quadrants 322 and the magnetic properties may vary in each of the four quadrants. The first end 304 of the bushing 300, may define a surface normal parallel with the longitudinal axis A and each quadrant may include an origin O′ and a terminus T′ when viewed along the surface normal, wherein the origin O′ defines a region 324 of a first magnetic intensity and the terminus T′ defines a region 326 of a second magnetic intensity that is different than the first magnetic intensity. In each quadrant 322, the origin O′ may precede the terminus T′ along the counterclockwise circumferential direction C, and the first magnetic intensity of the region 324 about the origin O′ may exceed the second magnetic intensity of the region 326 about the terminus T′.

As shown in FIGS. 7 and 8, in each quadrant 322 there may be a steady gradient 328 of magnetic intensity along the circumferential direction C from the origin O′ to the terminus T′. This variance in magnetic properties may be achieved in a number of ways. For example, each quadrant 322 may include different materials having different magnetic properties along the circumferential direction and/or each quadrant may include magnetic regions having a different surface area. The surface area of the magnetic regions may be continuous or discretized into many small regions, etc.

Essentially, the examples of the first end 304 of the bushing 300 and the shoulder 208 have magnetic properties that mirror each other. In FIG. 7, the regions of greatest magnetic intensity O, O′ are initially aligned with areas of weakest magnetic intensity T, T′ so that enough of a magnetic force is created to hold the bushing 300 in the pull zone 214 but not completely lock the bushing 300 into place. When the bushing 300 is rotated ninety degrees as depicted in FIG. 8, the areas of greatest magnetic intensity O, O′ are aligned, increasing the magnetic force to a point where the bushing 300 is locked into place.

As shown in FIG. 6, it is contemplated that additional magnetic regions 330, 226 may be disposed along the circumference 312 of the bushing 300 and the inner perimeter 228 of the aperture 204 of the front head 202 such in diametrically opposing quadrants such that when the bushing 300 is rotated, these additional regions would also align, increasing the locking force even more. Other configurations of the magnetic regions of the bushing and the front head are possible.

### INDUSTRIAL APPLICABILITY

In practice, a magnetic retention device, a hammer assembly, a bushing and/or an assembly, subassembly or component of a magnetic retention device, hammer assembly and a bushing according to any embodiment described herein may be sold, manufactured, bought etc. and used to attach a bushing to a hammer assembly, etc. In particular, a method of assembling the apparatus just described will now be addressed.

Manufacturing the magnetic regions discussed herein may involve the use of traditional DC permanent magnets or using 3D permanent magnetic printing technology to fabricate the desired magnetic areas. This may involve creating a thin sheet of the magnets that is adhered to a base layer of one or more components.

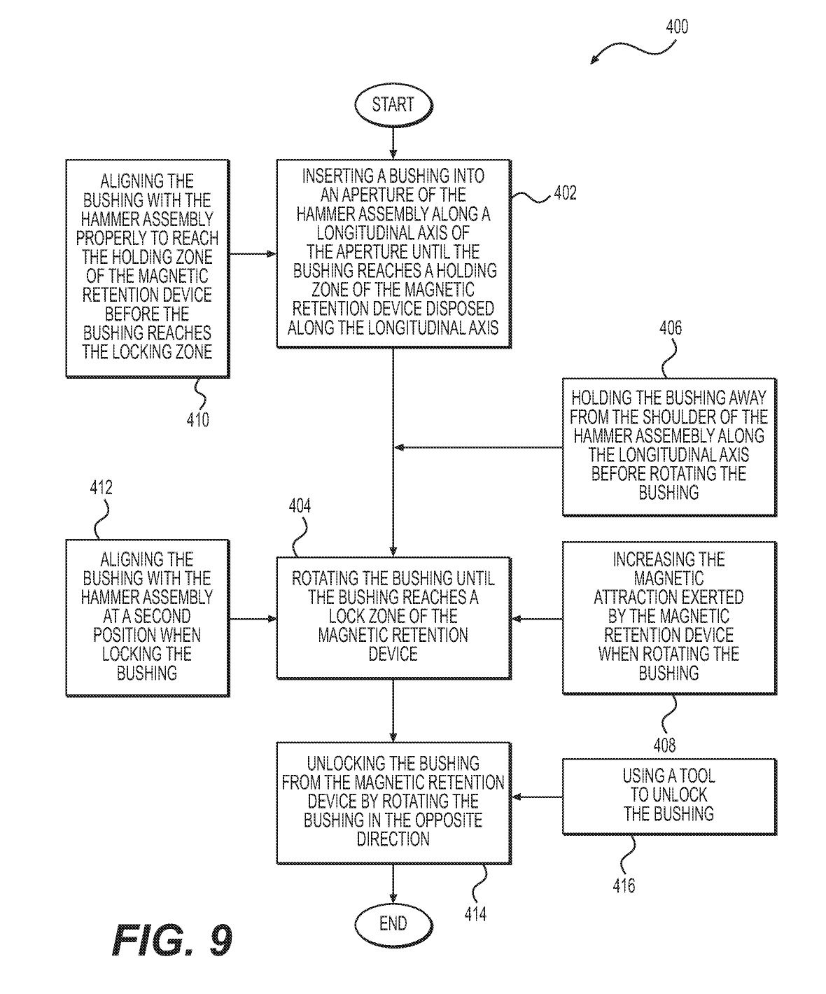

FIG. 9 is a flowchart showing the method of using the magnetic retention device. The method 400 comprises attaching a bushing to a hammer assembly using a magnetic retention device, the method comprising inserting a bushing into an aperture of the hammer assembly along a longitudinal axis of the aperture until the bushing reaches a holding zone of the magnetic retention device disposed along the longitudinal axis (see step 402) and rotating the bushing until the bushing reaches a lock zone of the magnetic retention device (see step 404).

The method may further comprise holding the bushing away from the shoulder of the hammer assembly along the longitudinal axis before rotating the bushing (see step 406).

In other embodiments, the method may further comprise increasing the magnetic force exerted between the bushing and the hammer assembly when rotating the bushing (see step 408).

In yet further embodiments, the method further comprises aligning the bushing with the hammer assembly to reach the holding zone of the magnetic retention device before the bushing reaches the locking zone (see step 410).

In some embodiments, the method further comprises aligning the bushing with the hammer assembly at a second position when locking the bushing (see step 412).

After locking the bushing, it may become desirable to replace the bushing. Then, the method may comprise unlocking the bushing from the magnetic retention device by rotating the bushing in the opposite direction (see step 414). This step may involve using a tool to unlock the bushing (see step 416). This may involve the use of a spanner wrench or the like.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. A bushing comprising:
a generally annular cylindrical body defining a longitudinal axis, a radial direction and a circumferential direction;
a first end and a second end disposed along the axis;
and defining a thru-hole extending from the first end to the second end, wherein the first end includes magnetic properties varying along the circumferential direction of the bushing.

2. The bushing of claim 1 wherein the first end defines four ninety-degree quadrants and the magnetic properties vary in each of the four quadrants.

3. The bushing of claim 2 wherein the first end defines a surface normal and each quadrant includes an origin and a terminus when viewed along the surface normal, wherein the origin defines a region of a first magnetic intensity and the terminus defines a region of a second magnetic intensity that is different than the first magnetic intensity.

4. The bushing of claim 3 wherein in two quadrants the origin precedes the terminus along the counterclockwise circumferential direction, and the first magnetic intensity of the region about the origin exceeds the second magnetic intensity of the region about the terminus.

5. The bushing of claim 4 wherein in each quadrant there is a steady gradient of magnetic intensity along the circumferential direction from the origin to the terminus.

6. The bushing of claim 5 wherein each quadrant includes different materials having different magnetic properties.

7. The bushing of claim 5 wherein each quadrant includes magnetic regions having a different surface area.

8. A hammer assembly configured to receive a bushing, the hammer assembly comprising:
a front head defining a bushing receiving aperture including a free end defining the bushing receiving aperture and a shoulder configured to abut the bushing;
wherein the aperture defines a longitudinal axis, a radial direction and a circumferential direction, and wherein the shoulder includes magnetic properties varying along the circumferential direction of the aperture.

9. The hammer assembly of claim 8 wherein shoulder defines four ninety-degree quadrants and the magnetic properties vary in each of the four quadrants.

10. The hammer assembly of claim 9 wherein the shoulder defines a surface normal and two quadrants include an origin and a terminus when viewed along the surface normal, wherein the origin defines a region of a first magnetic intensity and the terminus defines a region of a second magnetic intensity that is different than the first magnetic intensity.

11. The hammer assembly of claim 10 wherein in the two quadrants the origin precedes the terminus along the counterclockwise circumferential direction, and the first magnetic intensity of the region about the origin exceeds the second magnetic intensity of the region about the terminus.

12. The hammer assembly of claim 11 wherein in each quadrant there is a steady gradient of magnetic intensity along the circumferential direction from the origin to the terminus.

13. The hammer assembly of claim 12 wherein each quadrant includes different materials having different magnetic properties.

14. The hammer assembly of claim 12 wherein each quadrant includes magnetic regions having a different surface area.

15. A method for attaching a bushing to a hammer assembly using a magnetic retention device, the method comprising:
inserting a bushing into an aperture of the hammer assembly along a longitudinal axis of the aperture until the bushing reaches a holding zone of the magnetic retention device disposed along the longitudinal axis; and
rotating the bushing until the bushing reaches a lock zone of the magnetic retention device.

16. The method of claim 15 further comprising holding the bushing away from the shoulder of the hammer assembly along the longitudinal axis before rotating the bushing.

17. The method of claim 15 further comprising aligning the bushing with the hammer assembly to reach the holding zone of the magnetic retention device before the bushing reaches the locking zone.

18. The method of claim 15 further comprising increasing the magnetic attraction exerted by the magnetic retention device when rotating the bushing.

19. The method of claim 15 further comprising aligning the bushing with the hammer assembly at a second position when locking the bushing.

20. The method of claim 15 further comprising unlocking the bushing from the magnetic retention device by rotating the bushing in the opposite direction.
